(19) United States
(12) Patent Application Publication
(10) Pub. No.: US 2024/0091820 A1
(43) Pub. Date: Mar. 21, 2024

(54) PAINT BRUSH AND ROLLER WASHER

(71) Applicant: David A. BALMER, Opelika, AL (US)

(72) Inventor: David A. BALMER, Opelika, AL (US)

(21) Appl. No.: 18/511,434

(22) Filed: Nov. 16, 2023

Related U.S. Application Data
(63) Continuation-in-part of application No. 18/095,664, filed on Jan. 11, 2023.
(60) Provisional application No. 63/298,344, filed on Jan. 11, 2022.
(60) Provisional application No. 63/298,349, filed on Jan. 11, 2022.

(51) Int. Cl. B08B 3/02; A46B 17/06; B44D 3/00

(52) U.S. Cl. CPC B08B 3/022; A46B 17/06; B44D 3/006; A46B 2200/202; B08B 2203/0264

(57) ABSTRACT

A paint applicator washer for washing paint applicators, such as for example paint brushes and paint rollers. The paint applicator washer includes at least one spray tube with a hose connector or adapter at one end thereof and at least one nozzle provided along the length of the at least one spray tube. When connected to a hose supplying washing fluid, such as for example water, the washing fluid is ejected from the at least one nozzle as a pressurized stream or jet which can be directed at used paint applicators to wash out paint and other debris therefrom.

### CROSS-REFERENCE TO RELATED APPLICATION

This application is a continuation-in-part of U.S. patent application Ser. No. 18/095,664 filed Jan. 11, 2023, which claims the benefit of U.S. Provisional Patent Application Ser. No. 63/298,344 filed Jan. 11, 2022, and U.S. Provisional Patent Application Ser. No. 63/298,349, filed Jan. 11, 2022, the entireties of both are hereby incorporated herein by reference for all purposes.

### TECHNICAL FIELD

The present invention relates generally to the field of cleaning apparatuses, and more particularly to apparatuses for cleaning and/or washing paint applicators.

### BACKGROUND

Paint applicators such as for example paint brushes and paint rollers allow users to paint large areas more efficiently and effectively. However, the effectiveness of these paint applicators can degrade quickly if they are not properly cleaned and maintained. Particularly, improper care of paint brushes and paint rollers can lead to build-up of dried paint, dirt, and other residue which can lead to imperfect application of paint. Accordingly, it can be seen that needs exist for quickly and properly cleaning and maintaining used paint brushes and paint rollers. It is to the provision of apparatuses used to wash and clean paint brushes and paint rollers meeting these and other needs that the present invention is primarily directed.

### SUMMARY

In example embodiments, the present invention provides an apparatus for washing paint applicators, such as for example paint brushes and paint rollers. The apparatus is generally configured to be fluidly connected to a hose supplying washing fluid, such as for example water. The washing apparatus generally includes a spray tube with a hose connector or adapter for releasably securing the washing apparatus to the hose. The spray tube includes one or more nozzles configured to direct and/or modify the flow characteristics, such as for example the rate of flow, speed, direction, shape, and/or the pressure of the washing fluid stream or jet dispersed or ejected from the spray tube.

In one aspect, the present invention relates to a paint applicator washer used to wash used paint applicators with a washing fluid supplied from a hose. The paint applicator washer includes a first spray tube extending between a first proximal end and a second distal end, one or more first nozzles provided along the first spray tube, a hose coupler for detachably connecting the first spray tube to the hose, and an end cap secured to a distal end of the spray tube, opposite the proximal end.

Optionally, the paint applicator washer further includes one or more bristle spreaders. The one or more bristle spreaders may comprise angled or pointed tips to help penetrate and spread apart the bristles. Moreover, the one or more bristle spreaders may be axially aligned to the one or more nozzles.

Optionally, the paint applicator washer may include a fluid flow control switch for controlling the flow of washing fluid from the hose.

Optionally, the paint applicator washer may include a second spray tube extending from the first, proximal end of the first spray tube in a direction substantially transverse to the first spray tube, the second spray tube extending between a first, proximal end and a second, distal end, wherein the first, proximal ends of the first and second spray tubes are adjacent one another. Additionally, the second spray tube may comprise one or more second nozzles. Additionally, the one or more first nozzles may be positioned adjacent the first, proximal end of the first spray tube and the one or more second nozzles may be positioned adjacent the second, distal end of the second spray tube.

Optionally, the paint applicator washer may further include a splash guard to minimize splatter/splashing of washed-out paint and/or washing fluid during use.

In another aspect, the invention relates to a washing attachment for a hose. The washing attachment includes a tubular main spray body with a hose coupler for fluidly connecting the main spray body to the hose, a plurality of nozzles aligned along a length of the tubular main spray body; and a plurality of bristle spreaders provided over the plurality of nozzles.

Preferably, the washing attachment includes four nozzles and four bristle spreaders. The bristles spreaders may have angled tips—preferably tips angled approximately 45 degrees.

In still another aspect, the invention relates to a paint applicator cleaner for use with a hose. The paint applicator cleaner includes a main tube extending between a first end and a second end, a hose coupler attached to the first end of the main tube, a first spray tube extending between a first end and a second end, and one or more first nozzles secured along the first spray tube. Preferably, the first end of the first spray tube is fluidly connected to the second end of the main tube. Preferably, each of the one or more first nozzles are surrounded by a tubular structure with a slanted tip.

Optionally, the paint applicator cleaner further includes a second spray tube extending between a first end and a second end, wherein the first end of the second spray tube is fluidly connected to the second end of the main tube. Additionally, the paint applicator cleaner may include one or more second nozzles secured along the second spray tube. Preferably, the one or more first nozzles are positioned adjacent the first end of the first spray tube and the one or more second nozzles are positioned adjacent the second end of the second spray tube.

Optionally, the paint applicator cleaner further includes a flow control switch or valve to control the flow of washing fluid from the hose.

Optionally, the paint applicator cleaner further includes a splash guard providing cover around the paint applicator during wash to minimize splashing and splatter of excess paint and washing fluid to the surrounding.

In yet another aspect, the present invention is an apparatus for washing used paint rollers. In one example embodiment, the present invention is a paint roller washer for removable attachment to a hose for washing a paint roller with washing fluid. The paint roller washer comprises a main tube having a first end and a second end, a spray head fluidly connected to a first end of the main tube, and a coupler for removably coupling the paint roller washer to the hose. The spray head comprises one or more inwardly directed nozzles. The coupler is provided at the second end of the main tube.

Optionally, the paint roller washer may further comprise an elongated and tubular splash cover surrounding at least a portion of the spray head, the splash cover extending between a first end and a second end. Additionally, the splash cover may comprise a slot extending between a first end and a second end.

Optionally, the paint roller washer may further comprise a securing component for securing the paint applicator washer on a support surface for hands-free operation.

Optionally, the paint roller washer may further comprise an end cap removably secured to a second end of the splash cover. The end cap may comprise a drain port for removably receiving a drain hose.

Optionally, the paint roller washer may further comprise a control valve for controlling a flow of washing fluid therethrough.

Preferably, the nozzles are angularly offset in both a lateral direction and a longitudinal direction. Alternatively, the nozzles may be angularly offset in a lateral direction or a longitudinal direction, but not both. Alternatively, or additionally, at least one of the nozzles may be angularly offset in a first longitudinal direction and at least another one of the nozzles is angularly offset in a second longitudinal direction substantially opposite the first longitudinal direction.

Preferably, the main tube and coupler extend in parallel to the splash cover.

In another example embodiment, the present invention relates to a washing apparatus for cleaning a paint roller having a roller head secured to a wire frame. The washing apparatus comprises an elongated splash cover, a securing component for securing the washing apparatus on a support surface, and a plurality of nozzles aligned annularly within the splash cover. The splash cover comprises a first, open end and a second end opposite the first, open end, wherein the first, open end is configured for receiving the roller head of the paint roller, wherein the splash cover further comprises a slot extending from the first, open end towards the second end. The slot is configured for slidably moving the wire frame of the paint roller therethrough. Additionally, at least one of the nozzles is angularly offset in a first longitudinal direction and at least another one of the nozzles is angularly offset in a second longitudinal direction substantially opposite the first longitudinal direction.

Preferably, each nozzle is further angled in a lateral direction with respect to a respective radius.

Optionally, the washing apparatus further comprises a sprayer and the nozzles are provided along the sprayer.

Preferably, the sprayer is detachable from the splash cover. Alternatively, the sprayer may be permanently secured to an interior surface of the splash cover.

Preferably, the washing apparatus further comprises a securing component for securing the washing apparatus on a support surface for hands-free operation.

In yet another example embodiment, the present invention relates to an apparatus for washing a paint applicator with an axial axis. The apparatus comprises a main tube portion extending between a first proximal end and a second distal end opposite the first proximal end and comprising a longitudinal portion and a transverse portion, a washing fluid inlet with a control valve at the second end of the main tube portion for receiving and controlling the flow of washing fluid therethrough, and an annular spray head fluidly connected to the first proximal end of main tube portion. The spray head comprises a plurality of nozzles angularly offset in the longitudinal and lateral directions from their respective radial axes such that washing fluid ejected from the nozzles impact the paint applicator at least partially off center so as to cause the paint applicator to rotate about its axial axis and impact the paint applicator from different angles to help dislodge paint and debris from the paint applicator.

Optionally, the paint applicator further comprises a tubular protective cover surrounding the spray head.

Optionally, the paint applicator further comprises a securing mechanism for securing the apparatus for washing the paint applicator to a support surface for hands-free operation.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 shows flex lines of new and used paint brushes.

FIG. 2 is an exploded view of a paint brush washer according to an example embodiment of the present invention.

FIG. 3 shows use of the paint brush washer of FIG. 2 to clean a paint brush according to an example method of use.

FIG. 4 shows a paint roller washer according to another example embodiment of the present invention.

FIG. 5 shows a paint roller splash guard coupled to a paint roller according to yet another example embodiment of the present invention.

FIG. 6 shows a paint roller washer according to yet another example embodiment of the present invention.

FIG. 7 is a side view of the paint roller washer of FIG. 6 wherein the outer cover is not shown.

FIG. 8 is a top view of the paint roller washer of FIG. 6.

FIG. 9 is a cross-sectional view of a spray head of the paint roller washer of FIG. 8.

FIG. 10 is a detailed cross-sectional showing an orientation of a nozzle on the spray head of FIG. 9.

FIG. 11 shows a paint roller washer according to still another example embodiment of the present invention.

FIG. 12 shows a paint roller washer according to yet another example embodiment of the present invention.

FIG. 13 is a top view of the paint roller washer of FIG. 12.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

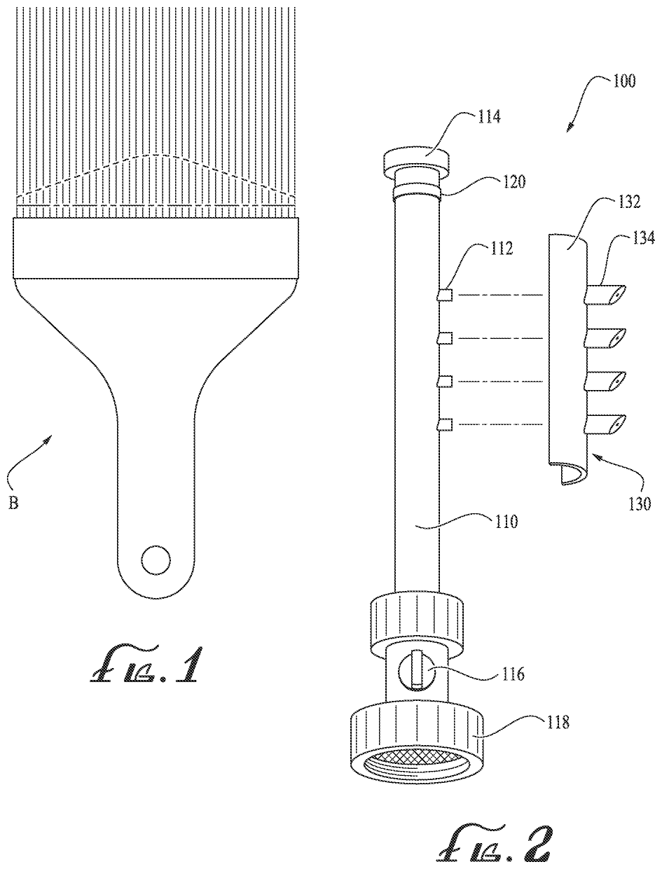

Painting apparatuses, such as for example paint brushes and paint rollers, are used to apply paint and other coating substances on surfaces efficiently and effectively. However, failure to properly clean the paint brushes and paint rollers after use can damage or deteriorate the quality of the apparatuses themselves and/or their functionality. Indeed, paint left on the brush bristles can harden and damage the fibers, discolor subsequent paint jobs, and/or lead to uneven application and finishes. For example, FIG. 1 shows a conventional paint brush B. If the paint brush is new or properly washed and maintained, the bristles flex or bend about the long-short-short dash line. However, if the brush is not washed and maintained properly, hardened paint, dirt, and other residues can particularly accumulate near the base of the brush head and inside the ferrule (i.e., where the bristles connect to the brush handle). This can cause the bristles to flex about the short dash line, which can negatively change how the brush functions/operates, cause the bristles to fling paint during use, and lead to frayed brush heads.

Similarly, paint rollers are also susceptible to issues if not properly washed and maintained after each use. For example, paint rollers typically include a roller cover attached to a paint roller frame. The roller cover typically includes a cylindrical core with an applicator material, such as for example pile fabric or foam rubber material, secured to the cylindrical core and is configured to absorb paint and transfer it to a surface to be painted. However, if the paint roller covers are not properly washed or maintained, paint hardens on the applicator material leading to uneven or blotchy application of paint on the painted surface. Therefore, it is helpful to properly wash paint applicators such as paint brushes and paint rollers after each use to help protect and keep the paint applicators functioning as intended. It is to the provision of paint applicator washers used to wash and clean paint applicators meeting these and other needs that the present invention is primarily directed.

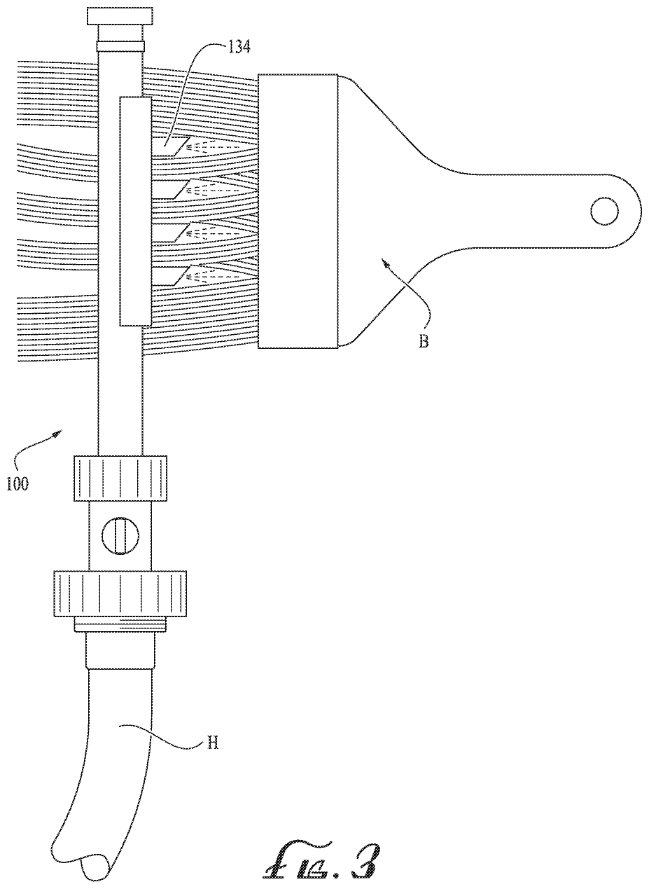

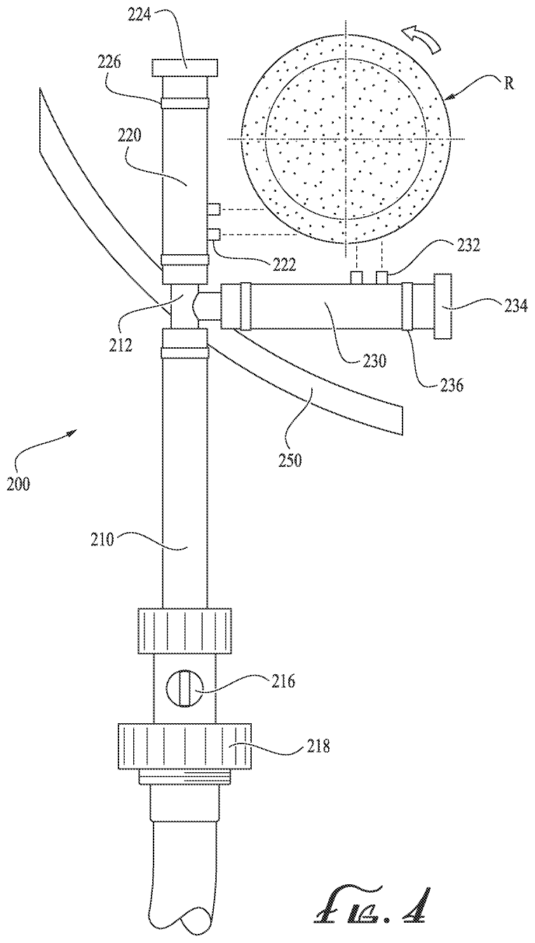

With reference now to the drawing figures, wherein like reference numbers represent corresponding parts throughout the several views, FIGS. 2 and 3 show a paint brush washer 100 according to an example embodiment of the present invention. Generally, the paint brush washer 100 is configured for removable attachment or connection to a hose, such as for example a garden hose, to assist or ease washing out paint, or other applicable substances such as for example stains, lacquer, or oils, from used paint brushes B. Specifically, the paint brush washer 100 helps penetrate and spread apart the bristles so that pressurized washing fluid, such as for example water, air, or other cleaning agents, can be directed or guided towards the ferrule to remove and prevent accumulation of paint at the base of the bristles and inside the ferrule which can lead to impaired functionality of the affected paint brush as discussed above. In example embodiments, the paint brush washer measures between about 6 and 10 inches in length, or more preferably about 8 inches in length, and is preferably configured for hand-held operation. However, it will be appreciated by those skilled in the art that the length of the paint brush washer 100 may be shorter than 6 inches or longer than 10 inches.

As shown in FIGS. 2 and 3, the paint brush washer 100 includes a main spray tube 110. The spray tube 110 includes a hollow, tubular body having an exterior or outer wall and extending between a first, proximal end and a second, distal end. At the first, proximal end, the paint brush washer 100 includes a hose coupler or connector 118 configured to allow coupling and decoupling of the paint brush washer 100 from a hose H. In example embodiments, the spray tube 110 comprises a 0.5 inch diameter cross-linked polyethylene (PEX) pipe or tube and includes a threaded hose coupler 118 configured for removably securing the paint brush washer to a reciprocally threaded end of the hose H. Preferably, the hose coupler 118 further includes an operable flow control valve or switch 116 configured to control the flow of washing fluid from the hose to the spray tube 110. In some example embodiments, the hose coupler 118 may be configured to be tightened by hand and without the use of additional tools. In other example embodiments, the spray tube 110 may comprise other suitable materials and the brush washer may incorporate other suitable mechanisms or mechanical means known in the art for coupling the spray tube 110 to the hose H. Optionally, the hose coupler 118 may include fixed or removable filters or mesh liners to filter dirt and/or debris in the washing fluid from entering the paint brush washer 100 preventing clogs in the paint brush washer. Optionally, the hose coupler 118 may further include one or more elastic washers or gaskets to ensure a water-tight seal between the paint brush washer 100 and the hose H.

The second, distal end (generally opposite the first, proximal end) of the main spray tube 110 is closed or plugged. In example embodiments, for example, the paint brush washer 100 is provided with an end cap or plug 114 secured to the second, distal end of the main spray tube 110. According to example embodiments, the end cap 114 is friction-fitted or push-fitted in the open distal end of the spray tube 110 forming a closed end. In other example embodiments, the second, distal end of the spray tube 110 may otherwise be closed or blocked off by other suitable means. Optionally, the paint brush washer 100 may further include a locking ring 120 to help secure the end cap 114 to the spray tube 110.

Between the first, proximal and second, distal ends of the spray tube 110, the paint brush washer 100 includes one or more nozzles 112. The nozzles 112 are configured to direct and/or modify the flow characteristics, such as for example the rate of flow, speed, direction, shape, and/or the pressure of the washing fluid stream or jet dispersed or ejected from the spray tube 110. Preferably, the nozzles 112 are configured to produce a stream or jet of washing fluid with sufficient velocity and pressure to remove both dried and fresh paint, or other coating substances, from the paint brush bristles and ferrule without the need of additional scrubbing, scraping, brushing, and/or other cleaning methods. In example embodiments, the nozzles 112 are provided along a length of the spray tube 110 and spaced a predetermined distance apart from one another. In the depicted embodiment, for example, the spray tube 110 includes four nozzles 112 spaced about 0.2-1.0 inches apart from one another, preferably about 0.3-0.75 inches apart from one another, or more preferably about 0.4 inches apart from one another. Optionally, the nozzles may be adjustable to modify certain characteristics such as for example the rate of flow, speed, direction, shape, and/or the pressure of the jet or stream of washing fluid ejected from the nozzles.

As shown in FIG. 2, the brush washer 100 further includes a bristle spreader assembly 130 including one or more bristle spreaders 134 secured to a base plate or cover 132. In example embodiments, the bristle spreaders 134 are tubular and are axially aligned to the nozzles 112. Preferably, the bristle spreaders 134 are aligned to the nozzles 112 so that washing fluid jet discharged from the corresponding nozzles are not impeded by the bristle spreaders 134. The bristle spreaders 134 comprise angled or pointed tips which help penetrate and spread the bristles apart during use, as shown in FIG. 3. Specifically, spreading the bristles apart allows the water jets (indicated by the dashed lines in FIG. 3) to be expressly directed or guided towards the base of the brush head and the ferrule. In the depicted embodiment, for example, the exposed or free ends of the bristle spreaders comprise an angled tip at approximately 45-degree angle to create a sharp tip to penetrate and spread the bristles apart during use. In preferred embodiments, the bristle spreader assembly 130 is permanently affixed to the spray tube 110. In other example embodiments, the bristle assembly 130 may be configured for removable attachment to the spray tube 110 by for example snap fit coupling and/or other mechanical coupling means.

In example modes of use, the paint brush washer 100 is fluidly connected to the hose H, such as for example a garden hose, via hose connector 118. The hose supplies pressurized washing fluid, such as for example pressurized water, to the spray tube 110 whereby the pressurized fluid is discharged from the spray nozzles 112. Generally, the spray nozzles 112 are configured to produce pressurized jets of washing fluid with sufficient velocity and pressure to wash off fresh, and if applicable dried, paint from the bristles and ferrule. As shown in FIG. 3, the pointed tips of the bristle spreaders 134 are used to penetrate between the bristles and spread the bristles apart whereby the pressurized jets of washing fluid can be directed to the base of the brush head and ferrule to dislodge and/or wash-out dried paint and other debris therefrom. The paint brush washer 100 may further be used in a brushing/combing manner to further dislodge and/or wash-out dried paint from the bristles or spread apart bristles clumped together by for example dried paint. Moreover, when provided, the flow control switch 116 can be used to control the flow and supply of pressurized washing fluid from the hose H to the spray tube 110 and thereby the flow characteristics of the washing fluid discharged through the spray nozzles 112. For example, the flow control switch 116 may be used to completely shut off the supply of washing fluid to the paint brush washer 100 or to reduce/increase for example the velocity or pressure of the washing fluid exerted from the nozzles 112.

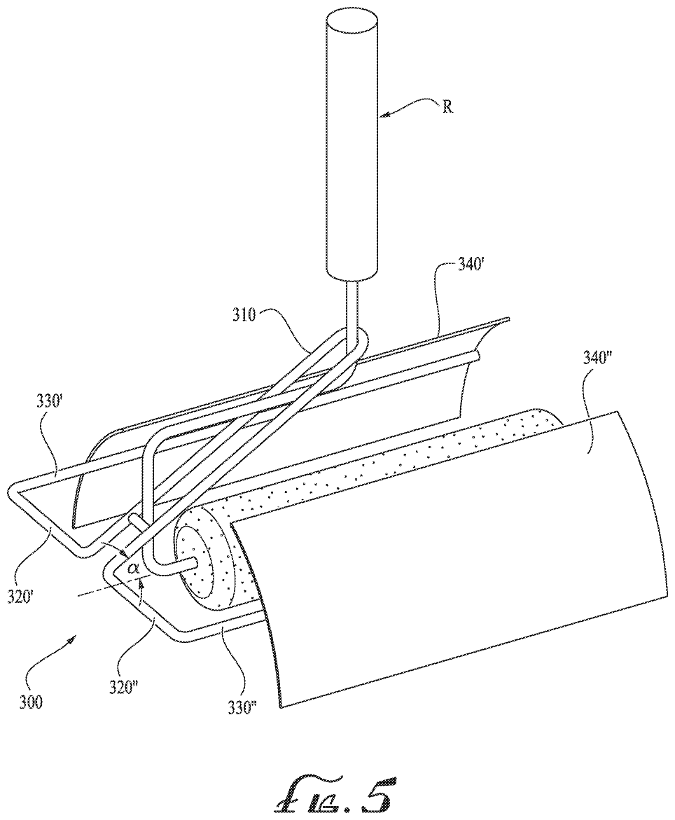

FIG. 4 shows a paint roller washer 200 according to an example embodiment of the present invention. Generally, the paint roller washer 200 is configured for removable attachment or connection to a hose, such as for example a garden hose, to help wash out paint and other debris and substances from used paint rollers R. In example embodiments, the paint roller washer 200 includes a main tube 210 extending between a first, proximal end and a second, distal end (generally opposite the first, proximal end). At the first, proximal end, the paint roller washer 200 includes a hose coupler or connector 218 configured for detachably coupling the paint roller washer 200 to a hose or a spout. Optionally, the paint roller washer 200 may be provided with a flow control valve or switch 216 to control the supply of washing fluid supplied to the paint roller washer 200.

In example embodiments, the paint roller washer 200 includes a plurality spray tubes fluidly connected to the main tube by a tee fitting or splitter 212. In the depicted embodiment, for example, the paint roller washer 200 includes a first spray tube 220 extending from the splitter 212 in a direction substantially longitudinal or parallel to the main tube 210 and a second spray tube 230 extending from the splitter 212 and substantially transverse or perpendicular to the main tube 210. As shown in FIG. 4, the first spray tube 220 is fluidly connected to the splitter 212 at a first, proximal end of the first spray tube. The second, distal end (generally opposite the first, proximal end) of the first spray tube 220 is closed or plugged for example with a first end cap or plug 224. Similarly, the second spray tube 230 is fluidly connected to the splitter 212 at a first, proximal end of the second spray tube. The second, distal end (generally opposite the first, proximal end) of the second spray tube 220 is closed or plugged for example with a second end cap or plug 234.

As shown in FIG. 4, the first and second spray tubes 220, 230 further include nozzles 222 and 232, respectively. In example embodiments, the paint roller washer 200 includes one or more first nozzles 222 between the first, proximal and second, distal ends of the first spray tube 220 and one or more second nozzles 232 provided between the first, proximal and second, distal ends of the second spray tube 230. Generally, the first and second nozzles 222, 232 are configured to direct and/or modify the flow characteristics, such as for example the rate of flow, speed, direction, shape, and/or the pressure of the washing fluid stream or jet dispersed or ejected from the spray tubes 220 and 230. Preferably, the nozzles 222 and 232 produce a stream or jet of washing fluid with sufficient velocity and pressure to remove both dried and fresh paint and other debris from the paint roller cover (e.g., the fabric pile or foam portions) without the need of additional scrubbing, scraping, brushing, and/or other cleaning methods. In example embodiments, the nozzles 222 and 232 are provided along the length of the first and second spray tubes 220, 230, respectively, and are spaced a predetermined distance apart from one another. In the depicted embodiment, for example, the spray tubes 220 and 230 include a pair of first nozzles 222 and a pair of second nozzles 232, respectively. Each pair of nozzles are spaced about 0.2-1.0 inches apart from one another, preferably about 0.3-0.75 inches apart from one another, or more preferably about 0.4 inches apart from one another. Optionally, the nozzles may be adjustable to modify certain characteristics such as for example the rate of flow, speed, direction, shape, and/or the pressure of the jet or stream of washing fluid ejected from the nozzles.

The first and second nozzles 222, 232 are preferably arranged such that the nozzles are offset from the centers of the first and second spray tubes 220, 230 respectively. For example, as shown in FIG. 4, the first nozzles 222 are positioned closer to the first, proximal end of the first spray tube 220 and the second nozzles 323 are positioned closer to the second, distal end of the second spray tube 230. In other words, the first nozzles 222 are positioned a first distance from the splitter 212 and the second nozzles are positioned a second distance greater than the first distance from the splitter 212. Alternatively, the position of the first and second nozzles 222, 232 may be reversed wherein the first nozzles 222 are positioned a first distance from the splitter 212 and the second nozzles are positioned a second distance lesser than the first distance from the splitter 212.

In example modes of use, the paint roller washer 200 is fluidly connected to a hose, such as for example a garden hose, via hose connector 218. The hose supplies pressurized washing fluid, such as for example pressurized water, to the main tube 210, first spray tube 220, and second spray tube 230 whereby the pressurized fluid is discharged from the first and second spray nozzles 222, 223. Generally, the spray nozzles 222, 232 are configured to produce pressurized jets of washing fluid with sufficient velocity and pressure to wash off fresh, and if applicable dried, paint from the roller cover material. As shown in FIG. 4, the first and second nozzles 222, 232 are offset from the centers of the first and second spray tubes 220, 230. Accordingly, the jets of washing fluid from nozzles 222 and 232 (as indicated by dashed lines) are exerted on the roller cover surface offset from the axial center thereof causing the roller cover to spin about its axial axis. For example, with the first nozzles positioned near the first, proximal end of the first spray tube 220 and the second nozzles positioned near the second, distal end of the second spray tube 230, the washing fluid jets from the nozzles cause the roller cover to spin in a first, counter-clockwise direction as indicated by the arrow in FIG. 4. Alternatively, if the first nozzles are positioned near the second, distal end of the first spray tube 220 and the second nozzles are positioned near the first, proximal end of the second spray tube 230, the washing fluid jets from the nozzles cause the roller cover to spin in a second, opposite clockwise direction.

Optionally, the flow control switch 216 can be used to control the flow and supply of pressurized washing fluid from the hose H to the spray tubes 220 and 230 and the flow characteristics of the washing fluid discharged through the spray nozzles 222 and 232. For example, the flow control switch 116 may be used to completely shut off the supply of washing fluid to the paint brush washer 200 or to reduce/increase for example the velocity or pressure of the washing fluid exerted from the nozzles 222, 232.

In preferred modes of use, the pressurize jets of washing fluids comprise sufficient velocity and/or pressure to (1) loosen and remove paint applied or embedded in the applicator material of the roller cover and (2) cause the roller cover to rotate at high speeds to remove excess paint and/or excess washing fluid therefrom by centrifugal force. Preferably, the paint roller washer 200 is moved back and forth longitudinally along the length of the roller cover to ensure the paint roller is fully washed. Optionally, the paint roller washer 200 may further include a splash guard 250 secured to the main tube 210 to help contain and shield against excess splatter from the spinning roller cover during use.

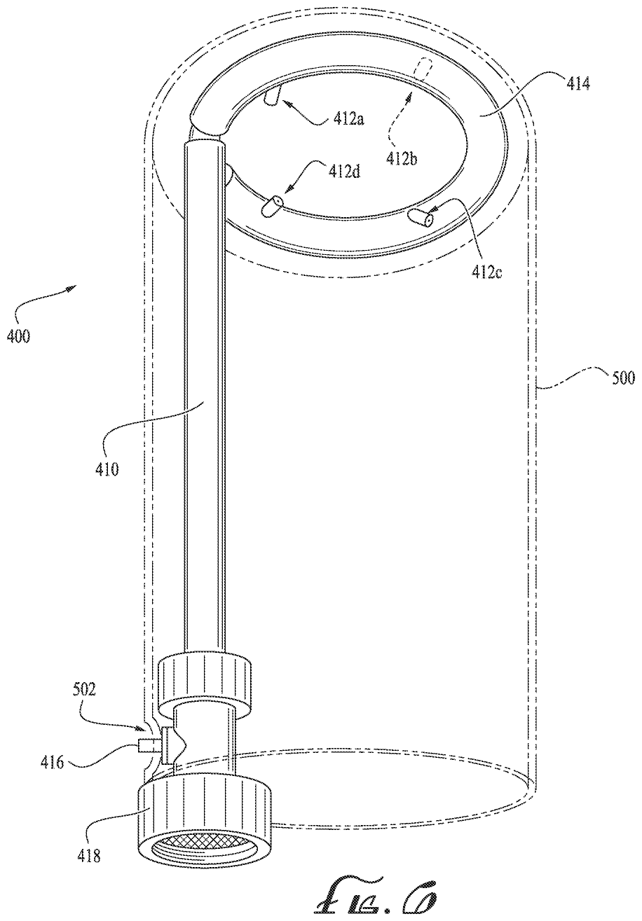

FIG. 5 shows a paint roller splash guard attachment or assembly 300 configured for use with paint rollers. Generally, the splash guard attachment 300 further helps contain and prevent splatter of washing fluid and excess paint as the paint roller cover is washed using the paint roller washer 200. In example embodiments, the paint roller splash guard attachment 300 is configured to be secured to the paint roller wire frame or body as shown in FIG. 5. The splash guard attachment 300 comprises a W-shaped wire frame including a U-shaped securing portion 310, lateral extensions portions 320′ and 320″, and longitudinal extension portions 330′ and 330″. The splash guard attachment 300 further includes arcuate splash guards or plates 340′ and 340″ secured to the longitudinal frame portions 330′ and 330″, respectively. In preferred modes of use, the splash guard attachment 330 is secured to the paint roller so that the splash guards 340′ and 340″ are generally coaxially aligned to the roller cover. In example embodiments, the U-shaped securing portion 310 is raised at angle α relative to the plane defined by the longitudinal and lateral extension portions. In example modes of use, the paint roller splash guard attachment 300 is slipped over the wire frame body of the paint roller wherein the wire frame body of the paint roller is secured between two elongated sides of the U-shaped securing portion 310. According to example modes of use, the splash guards 340′, 340″, and 250 provide almost 360 degrees of splash protection around the roller cover while washing the paint roller.

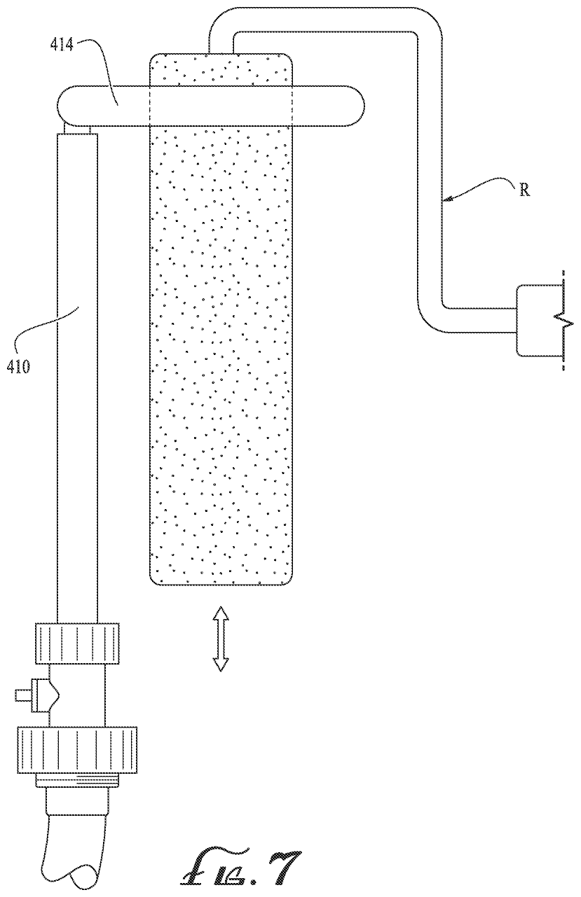

FIG. 6 shows another example embodiment of the paint roller washer 400. Generally, the paint roller washer 400 includes a main tube or body portion 410 extending between a first, proximal end and a second, distal end; a washer or spray head 414 fluidly connected to and extending from the second, distal end of the main tube 410; and a coupler or connector 418 attached to the first, proximal end of the main tube 410 configured for removably coupling the paint roller washer 400 to for example a hose or a spigot fluidly connected to a supply of washing fluid such as for example water supply. In some example embodiments, the paint roller washer 400 may also include a user operable flow control valve or switch 416 to control the flow of washing fluid therethrough and a splash guard 500 to contain and prevent splattering of excess washing fluid, paint, and/or debris from the paint roller as it is being washed/cleaned.

As described briefly above, and as shown in FIGS. 6 and 7, the main tube 410 comprises a tubing or piping extending from its first, proximal end to its second, distal end. At the first end of the main tube 410, the paint roller washer 400 comprises the coupler or coupling 418. In example embodiments, the coupler 418 is configured for removably coupling the paint roller washer 400 to for example a washing fluid conveying hose or spigot, such as for example a garden hose. In the depicted embodiment, for example, the paint roller washer 400 comprises a female threaded coupler 418 configured for removably securing the paint roller washer to a hose with a reciprocally threaded male coupling. Optionally, the hose coupler 418 may be configured to be tightened by hand and without the use of additional tools. In other example embodiments, the paint roller washer 400 may incorporate other suitable means known in the art for coupling the paint roller washer to the hose, such as for example quick connect couplings. Additionally, the hose coupler 418 may include fixed or removable filters to filter dirt and other debris from the washing fluid supplied to the paint roller washer 400 to help prevent undesired buildups and clogs therein. Preferably, the hose coupler 418 further includes an operable flow control valve or switch 416 allowing the user to control the flow of the washing fluid therethrough. Optionally, the hose coupler 418 may further include one or more washers or gaskets to ensure a water-tight seal between the paint roller washer 400 and the hose or spigot.

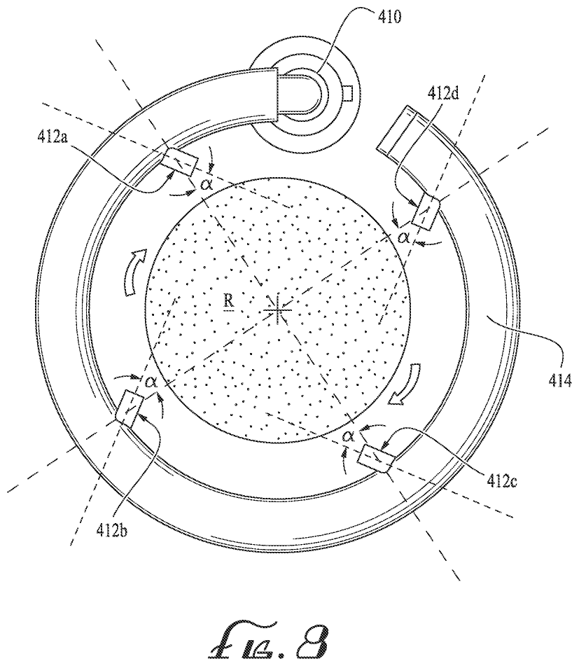

The paint roller washer 400 further comprises a spray head 414 fluidly connected to and extending from the second, distal end of the main tube 410. Generally, the spray head 414 comprises a tubing or pipe extending between a first end and a second end. The spray head 414 is fluidly connected at its first end to the second end of the main tube 410 and extends substantially transversely therefrom towards its second end, for example as shown in FIG. 8. In the depicted example embodiment, the second end of the spray head 414 tubing is closed or plugged; however, the second end may be fluidly connected to the first end forming a continuous or open loop.

According to example embodiments, the spray head 414 defines an opening, or a spray area, through which the paint roller cover or head of the paint roller is moved during use. For example, as shown in FIG. 8, the spray head 414 extends annularly between its first and second ends and defines a circular spray area at the center thereof. The spray head 414 is preferably substantially perpendicular to the main tube 410 so that the paint roller R may be moved along a path that is substantially parallel to the main tube 410. The spray head 414 may comprise other profile shapes and/or forms, such as for example polygonal, helical, semi-circular, etc., so that the spray head 414 at least partially surround or encircle the roller head of the paint roller during use. In some example embodiments, the spray head 414 may be acutely or obtusely angled relative to the main tube 410.

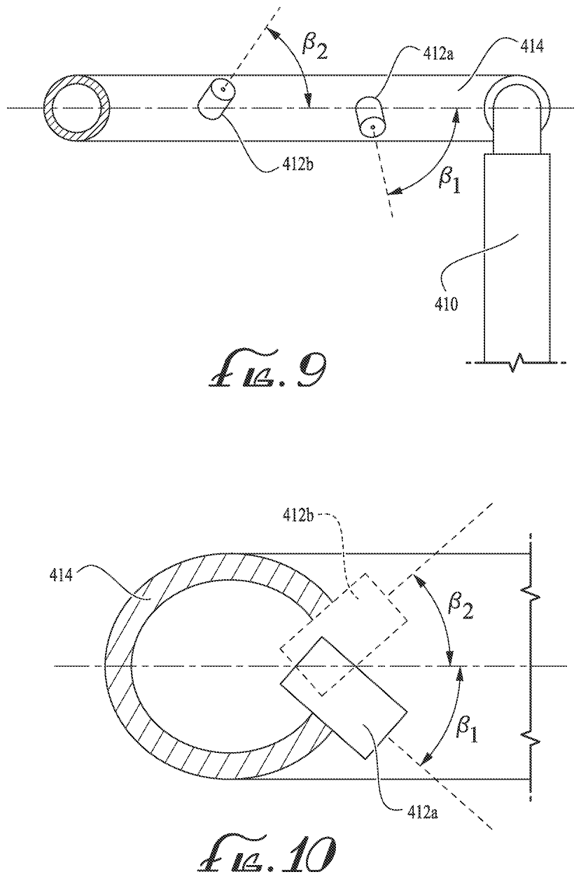

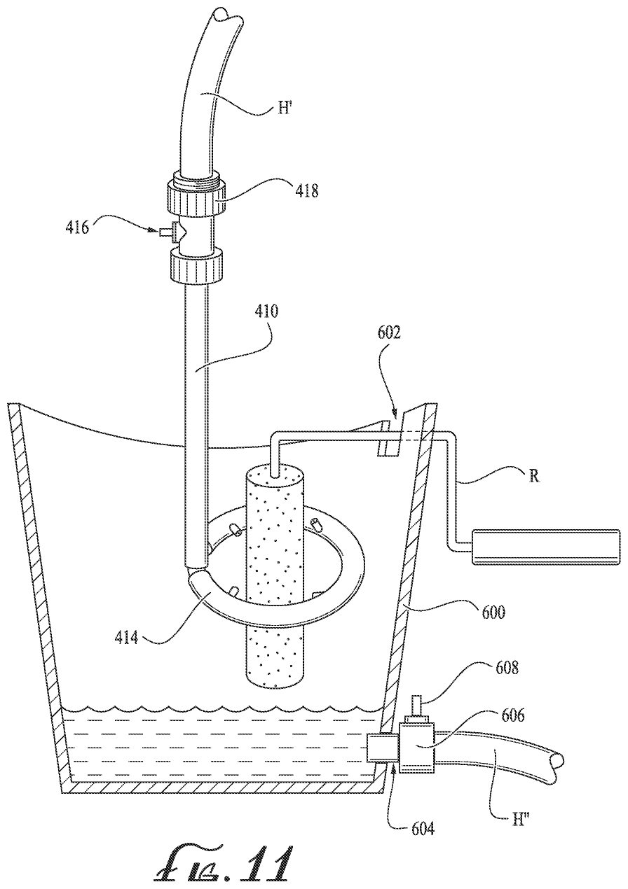

Generally, the spray head 414 comprises one or more spray nozzles 412 (e.g., 412a-412d). The spray nozzles are provided along the spray head 414 and are oriented to spray washing fluid inwardly or towards the center of the spray area defined by the spray head 414. In example embodiments, the spray nozzles 412 are provided along an inner or interior surface of the spray head 414 and are angularly offset so that the washing fluid from the nozzles 412 contact the roller head off-center to cause the roller head R to rotate about its axial axis, as shown in FIG. 8. As shown in FIGS. 8-10, each of the nozzles 412a, 412b, 412c, and 412d is angularly offset in both lateral and longitudinal directions (i.e., laterally offset α degrees from a respective radial line a plane defined by the spray head 414, as shown in FIG. 8, and longitudinally offset β degrees from the plane defined by the spray head 414, as shown in FIGS. 9 and 10). For example, in the depicted embodiment, each nozzle is angularly offset a degrees from its respective radius, or an axis extending from the center of the nozzle to the center of the spray area, in the lateral direction (i.e., along the plane of the spray head). Preferably, the nozzles 412a-412d are angularly offset in the same lateral direction but angularly offset alternatingly in opposing longitudinal directions. For example, the nozzle 412a is angularly offset pi degrees in a first longitudinal direction while nozzle 412b is angularly offset (32 degrees in a second longitudinal direction opposite the first direction. For example, nozzles 412a and 412c may be angularly offset in the longitudinal direction towards the first end of the main tube 410 while nozzles 412b and 412d are angularly offset in the opposite longitudinal direction (i.e., away from the first end of the main tube). In preferred embodiments, the nozzles are 412 are angularly offset about 40-55 degrees relative to the respective radii in the lateral direction and about ±1-45 degrees relative to the plane defined by the spray head in the longitudinal direction, or more preferably about 45-50 degree in the lateral direction and about ±1-10 degrees relative to the plane defined by the spray head in the longitudinal direction.

In preferred example embodiments, the nozzles are angularly offset in the lateral direction so that the washing fluid discharged therefrom contact the roller head R at an angle that is not directly perpendicular to the roller head. The angular impact of the washing fluid causes the roller head to rotate without the need of other external forces (e.g., the user need not rotate the roller head manually). Additionally, the nozzles are angularly offset preferably in opposing longitudinal directions to wash a larger area. The longitudinally opposed orientation of the nozzles also ensures the washing fluid impacts the paint roller head from different angles to help dislodge and wash off paint and other debris from the paint roller head. In other example embodiments, the nozzles 412 are angularly offset in the lateral direction or the longitudinal direction, but not both.

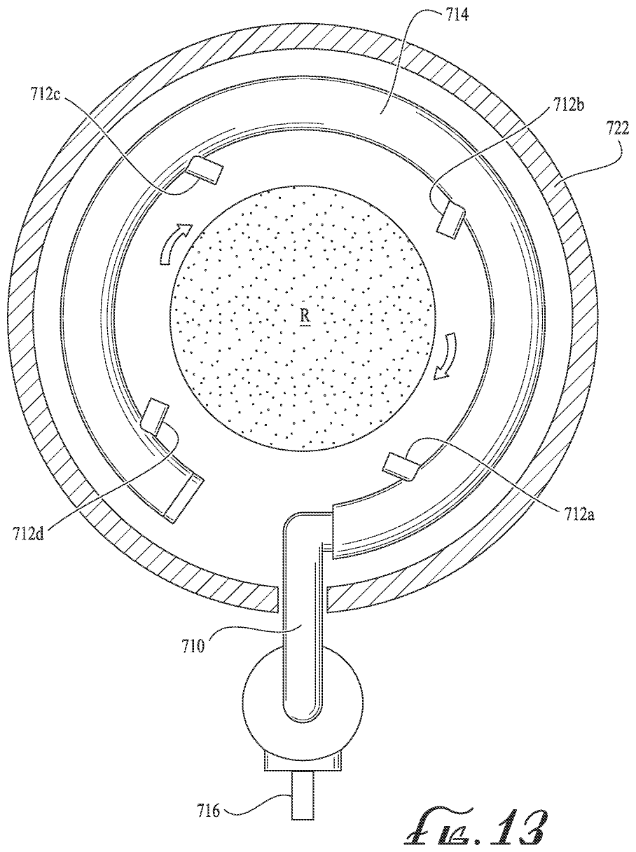

As shown in FIG. 6, the paint roller washer 400 may optionally comprise a splash guard 500 which acts as a protective cover or shield to protect the paint roller washer 400 from damage and contain/prevent splatter of washing fluid, paint, and other debris from the roller head during the wash. In example embodiments, the splash guard 500 is tubular and extends between a first, open end and a second, open end over the main tube 410, spray head 414 and at least a portion of the coupler 418 with the spray head 414 oriented towards the first end of the splash guard 500 and the coupler 418 positioned towards the end of the second end of the splash guard 500. In example embodiments, the first end of the splash guard 500 comprises an opening aligned to the opening or spray area defined by the spray head 414. During use, used (waste) washing fluid, along with paint and other debris dislodged from the roller head, is preferably drained through the second, open end but may be alternatively or additionally drained through the first, open end. In some example embodiments, the second end may be closed, for example via a removable end cap (e.g., similar to the removable end cap 724 shown in FIG. 12), and further comprise a drain. In other example embodiments, the splash guard 500 may further comprise an opening 502 providing access to the control valve 416 or other portions of the main tube, spray head, and/or coupler as desired. In still other example embodiments, the splash guard 500 further comprises a slot (e.g., similar to slot 726 as shown in FIG. 12) extending from the first end towards the second end. The slot is configured to receive the wire frame portion of the paint roller and allows the roller head to be moved axially through the spray head 412 and the corresponding spray area defined by the spray head 412.

According to example embodiments, the main tube 410 and the spray head 414 generally comprise tubing or pipes made from cross-linked polyethylene (PEX), acrylic, polycarbonate (PC), polyethylene (PE), polypropylene (PP), polyethylene terephthalate (PET), polyvinyl chloride (PVC), acrylonitrile-butadiene-styrene (ABS), or other similar plastic and/or non-plastic materials. In example embodiments, the main tube 410 comprises an external diameter between about ¼ in. and 1 in., preferably between about ⅜ in. and about ¾ in., and more preferably about ½ in. and about ⅝ in., and an internal diameter between about ⅛ in. and ⅞ in., preferably between about ¼ in. and about ⅝ in., and more preferably about ⅜ in. and about ½ in.

In example embodiments, the paint roller washer 400 has a length between about 12 in. and about 36 in., and preferably between about 18 in. and about 30 in., and a width between about 6 in. and about 16 in., and preferably between about 6 in. and about 10 in. In other example embodiments, the main tube 410 may comprise other dimensions and/or materials as desired or as appropriate per application. In example embodiments, the paint roller washer has a working pressure between about 45 psi and about 85 psi.

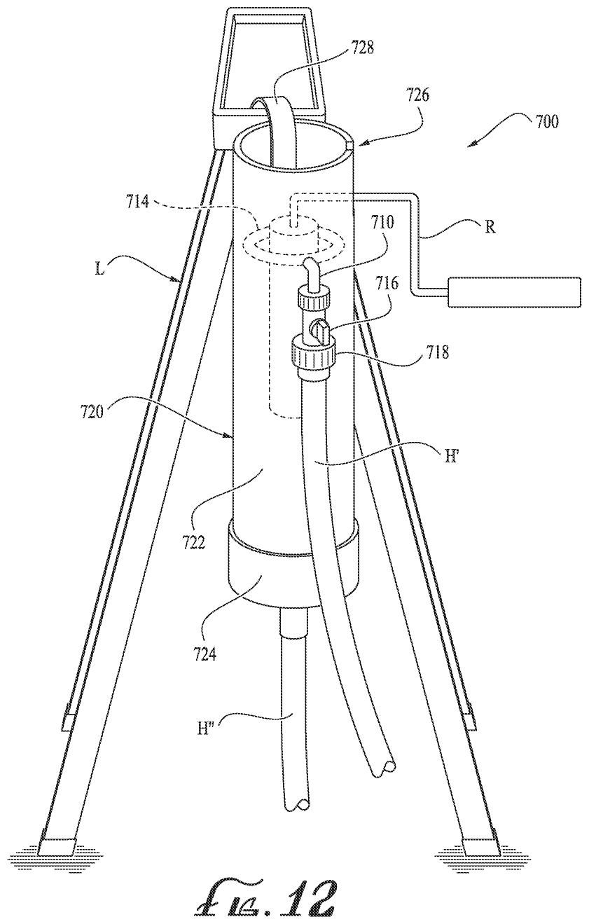

FIG. 11 shows use of the paint roller washer 400 with a waste catch or basin 600. The waste basin 600 is configured for use with the paint roller washer 400 and provides a reservoir or cavity to catch and collect waste fluid during use. Preferably, the waste basin 600 is configured to collect and retain a large volume, for example about 5 gallons, of waste fluid for selective disposal. For example, the waste basin 600 can be used to catch and retain waste fluid for later disposal where disposal of such waste fluid is prohibited or undesirable at the location the paint roller is washed. In example embodiments, the wash basin 600 comprises a basin floor having a first perimeter and a basin wall extending from the first perimeter of the basin floor, the upper edge of the basin wall defining a second perimeter. The waste basin 600 comprises a slot 602 provided along the second perimeter of the basin wall configured for receiving and securing therein the wire frame of paint roller R during use and a drain 604 for draining waste fluid collected in the wash basin. The drain 604 further comprises a control valve 608 for selective operation of the drain and a coupler 606 for removably coupling the waste basin 600 to for example a hose H″ to direct where the washing fluid is emptied or evacuated. In example modes of use, the paint roller washer is held over the wash basin 600 by a user with the spray head 414 positioned within the waste basin 600. With the paint roller R resting in the slot 602 and the roller head positioned in the spray area defined by the spray head 414, the spray head 414 is moved axially along the length of the paint roller head. As described above, as the spray head 414 is moved along the paint roller head, pressurized washing fluid is discharged from the spray nozzles 412 simultaneously washing and rotating the roller head. The used washing fluid, or the waste fluid, and paint and other debris removed from the roller head, is collected within the wash basin 600. The control valve 608 may be selectively operated to drain the collected waste washing fluid as desired. Where disposal of waste washing fluid is not permitted on location, the control valve 608 may be kept closed to retain the waste water within the basin until the waste fluid can be safely disposed.

FIGS. 12 and 13 show a paint roller washer 700 according to yet another example embodiment of the present invention. The paint roller washer 700 comprises main tube 710 extending from a first, proximal end and a second, distal end and comprising a longitudinal portion approximate the first, proximal end and a transverse portion approximate the second, distal end. A coupler or coupling 718 is provided at the first end of the main tube 710. Similar to couplers described above, the coupler 718 is configured for removably coupling the paint roller washer 700 to a supply of washing fluid for example via a hose H′. Similar to spray heads 414, 614 described above, a spray head 714 is fluidly connected to the second end of the main tube 710 and comprises a plurality of spray nozzles 712 (e.g., 712a-712d) positioned along an inner surface thereof. The nozzles are inwardly directed and, preferably, angularly offset (similar to nozzles 412a-412d described above). The coupler 718 may comprise a user operable control valve 716 to control the flow and supply of washing fluid into the paint roller washer 700 from the hose H″.

As shown in FIG. 13, the paint roller washer 700 further comprises a spray head 714 fluidly connected to and extending from the second, distal end of the main tube 710. Generally, the spray head 714 comprises a tubing or pipe extending between a first end and a second end. The spray head 714 is fluidly connected at its first end to the second end of the main tube 710 and extends to its second end, for example as shown in FIG. 13. In the depicted example embodiment, the second end of the spray head 714 tubing is closed or plugged; however, the second end may be fluidly connected to the first end forming a continuous or open loop.

According to example embodiments, the spray head 714 defines an opening, or a spray area, through which the paint roller cover or head of the paint roller is moved during use. For example, as shown in FIG. 13, the spray head 714 extends annularly between its first and second ends and defines a circular spray area at the center thereof. The spray head 714 is preferably substantially perpendicular to the longitudinal portion of the main tube 710 and extends laterally from the transverse portion of the main tube 710. The spray head 714 may comprise other profile shapes and/or forms, such as for example polygonal, helical, semi-circular, etc., so that the spray head 714 at least partially surround or encircle the roller head of the paint roller during use.

Generally, the spray head 714 comprises one or more spray nozzles 712 (e.g., 712a-712d). The spray head 714 and the nozzles 712 are substantially similar to the spray head 414 and nozzles 412 described above. For example, the spray nozzles are provided along the spray head 714 and are oriented to spray washing fluid inwardly or towards the center of the spray area defined by the spray head 714. In example embodiments, the spray nozzles 712 are provided along an inner or interior surface of the spray head 714 and are angularly offset so that the washing fluid from the nozzles 712 contact the roller head off-center to cause the roller head R to rotate about its axial axis. As shown in FIG. 13, each of the nozzles 712a, 712b, 712c, and 712d is angularly offset in both lateral and longitudinal directions. For example, in the depicted embodiment, each nozzle is angularly offset α degrees from its respective radius, or an axis extending from the center of each nozzle to the center of the spray area, in the lateral direction (i.e., along the plane of the spray head). Preferably, the nozzles 712a-712d are angularly offset in the same lateral direction but angularly offset alternatingly in opposing longitudinal directions (wherein the longitudinal direction is substantially perpendicular or transverse to the lateral direction). For example, the nozzle 712a is angularly offset in a first longitudinal direction while nozzle 712b is angularly offset in a second longitudinal direction opposite the first direction. For example, nozzles 712a and 712c may be angularly offset in the longitudinal direction towards a first end of the paint roller washer 700 while nozzles 712b and 712d are angularly offset in an opposite longitudinal direction towards a second end opposite the first end of the paint roller washer. In preferred embodiments, the nozzles are 712 are angularly offset about 40-55 degrees relative to the respective radii in the lateral direction and about ±1-45 degrees relative to the plane defined by the spray head in the longitudinal direction, or more preferably about 45-50 degree in the lateral direction and about ±1-10 degrees relative to the plane defined by the spray head in the longitudinal direction.

In preferred example embodiments, the nozzles are angularly offset in the lateral direction so that the washing fluid discharged therefrom contact the roller head R at an angle that is not directly perpendicular to the roller head. The angular impact of the washing fluid causes the roller head to rotate without the need of other external forces (e.g., the user need not rotate the roller head manually). Additionally, the nozzles are angularly offset preferably in opposing longitudinal directions to wash a larger area. The longitudinally opposed orientation of the nozzles also ensures the washing fluid impacts the paint roller head from different angles to help dislodge and wash off paint and other debris from the paint roller head. In other example embodiments, the nozzles 712 are angularly offset in the lateral direction or the longitudinal direction, but not both.

The paint roller washer 700 further comprises a splash cover or shield 720. The splash cover 720 comprises an elongated tubular body extending between a first end and a second end. At its first end, the splash cover 720 comprises a removable end cap 724 with a drain. Optionally, the drain may be adapted for receiving and removably coupling thereto a hose H″ allowing the user to direct the drainage of waste fluid as desired during use. For example, the drain may be threaded for coupling to a reciprocally threaded end of a garden hose or the drain may comprise a barbed nipple or fitting for installing thereon an open, free end of a hose. In some example embodiments, the end cap 724 may be permanently affixed or integrated to the splash cover 720.

In example embodiments, the second end of the splash cover 720 comprises an opening for receiving the roller head of the paint roller. A slot 726 extends longitudinally along a peripheral wall 722 of the splash cover 720 and is configured for slidably receiving the wire frame of the paint roller. Preferably, the slot 726 extends from the second end of the splash cover 720 to about where the spray head 714 is positioned within the splash cover.

According to example embodiments, the longitudinal portion of the main tube 710 extends parallel to the splash cover 720 and, preferably, remains close to splash cover 720 to minimize the overall cross-sectional footprint of the paint roller washer 700 to improve portability and ease of use. For example, the paint roller washer 700 comprises a diameter (or width) between about 6 in. and about 16 in., or preferably between about 6 in. and about 10 in. Moreover, maintaining the main tube 710 and the coupler 718 close and parallel to the splash cover 720 ensures the external supply hose is maintained at a substantially vertical position while the washer 700 is secured on a support surface for example by a securing hook (as described below). For example, if a hose is coupled perpendicularly to the paint roller washer 700, the weight of the hose and washing fluid in the hose can significantly alter the center of gravity and cause the paint roller washer 700 to tilt when hanging from a support surface (as described below), resulting in a less desirable orientation for moving the paint roller through the spray head.

As shown in FIG. 12, the paint roller 700 further comprises a means for securing it on a support surface. For example, in the depicted embodiment, the paint roller washer 700 comprises a securing hook 728 coupled to the splash cover 720. The securing hook allows the washer 700 to be secured or hung from a support surface, such as for example a top of a ladder, so that the user is not required to hold the washer 700 and the paint roller R at the same time. The securing hook 728 thereby frees up at least one of the user's hands and provides a more manageable and efficient paint roller washing experience.

According to example embodiments, the main tube 710 and the spray head 714 generally comprise tubing or pipes made from cross-linked polyethylene (PEX), acrylic, polycarbonate (PC), polyethylene (PE), polypropylene (PP), polyethylene terephthalate (PET), polyvinyl chloride (PVC), acrylonitrile-butadiene-styrene (ABS), or other similar plastic and/or non-plastic materials. In example embodiments, the main tube 410 comprises an external diameter between about ¼ in. and 1 in., preferably between about ⅜ in. and about ¾ in., and more preferably about ½ in. and about ⅝ in., and an internal diameter between about ⅛ in. and ⅞ in., preferably between about ¼ in. and about ⅝ in., and more preferably about ⅜ in. and about ½ in.

In example embodiments, the paint roller washer 700 has a length between about 12 in. and about 36 in., and preferably between about 18 in. and about 30 in., and a width between about 6 in. and about 16 in., and preferably between about 6 in. and about 10 in. In other example embodiments, the main tube 710 may comprise other dimensions and/or materials as desired or as appropriate per application. In example embodiments, the paint roller washer has a working pressure between about 45 psi and about 85 psi.

While the invention has been described with reference to example embodiments, it will be understood by those skilled in the art that a variety of modifications, additions and deletions are within the scope of the invention, as defined by the following claims.

What is claimed is:

1. A paint roller washer for removable attachment to a hose for washing a paint roller with washing fluid, comprising:
a main tube having a first end and a second end;
a spray head fluidly connected to a first end of the main tube, the spray head comprising one or more inwardly directed nozzles;
a coupler for removably coupling the paint roller washer to the hose, wherein the coupler is provided at the second end of the main tube; and
an elongated and tubular splash cover surrounding at least a portion of the spray head, the splash cover extending between a first end and a second end.

2. The paint roller washer of claim 1, further comprising a securing component for securing the paint applicator washer on a support surface for hands-free operation.

3. The paint roller washer of claim 1, further comprising an end cap removably secured to a second end of the splash cover.

4. The paint roller washer of claim 3, wherein the end cap comprises a drain port for removably receiving a drain hose.

5. The paint roller washer of claim 4, further comprising a control valve for controlling a flow of washing fluid therethrough.

6. The paint roller washer of claim 5, wherein the splash cover comprises a slot extending between a first end and a second end.

7. The paint roller washer of claim 1, wherein the nozzles are angularly offset in both a lateral direction and a longitudinal direction.

8. The paint roller washer of claim 1, wherein the nozzles are angularly offset in a lateral direction.

9. The paint roller washer of claim 8, wherein the nozzles are angularly offset in a longitudinal direction.

10. The paint roller washer of claim 9, wherein at least one of the nozzles is angularly offset in a first longitudinal direction and at least another one of the nozzles is angularly offset in a second longitudinal direction substantially opposite the first longitudinal direction.

11. The paint roller washer of claim 1, wherein the main tube and coupler extend in parallel to the splash cover.

12. A washing apparatus for cleaning a paint roller having a roller head secured to a wire frame, the washing apparatus comprising an elongated splash cover, a securing component for securing the washing apparatus on a support surface, and a plurality of nozzles aligned annularly within the splash cover, wherein the splash cover comprises a first, open end and a second end opposite the first, open end, wherein the first, open end is configured for receiving the roller head of the paint roller, wherein the splash cover further comprises a slot extending from the first, open end towards the second end, the slot being configured for slidably moving the wire frame of the paint roller therethrough, and wherein at least one of the nozzles is angularly offset in a first longitudinal direction and at least another one of the nozzles is angularly offset in a second longitudinal direction substantially opposite the first longitudinal direction.

13. The washing apparatus of claim 12, wherein each nozzle is further angled in a lateral direction with respect to a respective radius.

14. The washing apparatus of claim 12, further comprising a sprayer and wherein the nozzles are provided along the sprayer.

15. The washing apparatus of claim 14, wherein the sprayer is detachable from the splash cover.

16. The washing apparatus of claim 14, wherein the sprayer is permanently secured to an interior surface of the splash cover.

17. The washing apparatus of claim 12, wherein the washing apparatus further comprises a securing component for securing the washing apparatus on a support surface for hands-free operation.

18. An apparatus for washing a paint applicator with an axial axis, comprising:
a main tube portion extending between a first proximal end and a second distal end opposite the first proximal end and comprising a longitudinal portion and a transverse portion;
a washing fluid inlet with a control valve at the second end of the main tube portion for receiving and controlling the flow of washing fluid therethrough; and
an annular spray head fluidly connected to the first proximal end of main tube portion, the spray head comprising a plurality of nozzles angularly offset in the longitudinal and lateral directions from their respective radial axes such that washing fluid is ejected from the nozzles impact the paint applicator at least partially off center so as to cause the paint applicator to rotate about its axial axis and impact the paint applicator from different angles to help dislodge paint and debris from the paint applicator.

19. The apparatus of claim 18, further comprising a tubular protective cover and the main tube portion and the spray head is surrounded by the protective cover.

20. The apparatus of claim 19, further comprising a securing mechanism for securing the apparatus for washing the paint applicator to a support surface.
